(19) United States
(12) Patent Application Publication
(10) Pub. No.: US 2026/0280979 A1
(43) Pub. Date: Sep. 17, 2026

(54) METHOD OF MODEL SWITCHING SIGNALING FOR RADIO ACCESS NETWORK

(71) Applicant: Continental Automotive Technologies GmbH, Hannover (DE)

(72) Inventors: Hojin KIM, Regensburg (DE); Rikin SHAH, Langen, Hessen (DE); Andreas ANDRAE, Frankfurt am Main (DE); Osvaldo GONSA, Frankfurt (DE)

(73) Assignee: Continental Automotive Technologies GmbH, Hannover (DE)

(21) Appl. No.: 19/469,256

(22) PCT Filed: Mar. 26, 2024
(86) PCT No.: PCT/EP2024/058028

§ 371 Date: Sep. 25, 2025

(30) Foreign Application Priority Data
Mar. 27, 2023 (DE) 102023202799.2

(51) Int. Cl. H04L 41/0816

(52) U.S. Cl. CPC H04L 41/0816

(57) ABSTRACT

The present disclosure describes methods of using a list of AI/ML candidate models for model switching in wireless mobile communication system including base station e.g., gNB and mobile station e.g., UE. Alternative model(s) is applied to model switching operation autonomously based on the pre-configured mapping relationship information between model IDs and other associated parameter values. Therefore, model switching supports multiple alternative models to be switched to replace any outdated model depending on different model execution environment with varying models.

### CROSS-REFERENCE TO RELATED APPLICATIONS

This application is the United States National Phase under 35 U.S.C. § 371 of PCT International Patent Application No. PCT/EP2024/058028, filed on Mar. 26, 2024, which claims the benefit of German Patent Application No. 102023202799.2 filed on Mar. 27, 2023, the disclosures of which are hereby incorporated by reference herein in their entireties.

### TECHNICAL FIELD

The present disclosure relates to AI/ML based model switching, where techniques for pre-configuring and signaling the specific information about mapping relationship information using association between models and other index values are presented.

### BACKGROUND

In 3GPP (Third Generation Partnership Project), one of the selected study items as the approved Release 18 package is AI/ML (artificial intelligence/machine learning) as described in the related document (RP-213599) addressed in 3GPP TSG (Technical Specification Group) RAN (Radio Access Network) meeting #94e. The official title of AI/ML study item is “Study on AI/ML for NR Air Interface”, and currently RAN WG1 (Working Group 1) and WG2 are actively working on specification, and is incorporated herein by reference.

The goal of this study item is to identify a common AI/ML framework and areas of obtaining gains using AI/ML based techniques with use cases. According to 3GPP, the main objective of this study item is to study AI/ML framework for air-interface with target use cases by considering performance, complexity, and potential specification impact. In particular, AI/ML model, terminology and description to identify common and specific characteristics for framework will be one of key work scope. Regarding AI/ML framework, various aspects are under consideration for investigation and one of key items is about lifecycle management of AI/ML model where multiple stages are included as mandatory for model training, model deployment, model inference, model monitoring, model updating etc. Earlier, in 3GPP TR 37.817 for Release 17, titled as Study on enhancement for Data Collection for NR and EN-DC, UE (user equipment), incorporated herein by reference, mobility was also considered as one of AI/ML use cases and one of scenarios for model training/inference is that both functions are located within RAN node.

US 2023069342, incorporated herein by reference, describes how to assist determination of the model update time in consideration of cost for the update of a model.

US 2023022737, incorporated herein by reference, explains supporting generation of machine learning model when a certain machine learning model is changed.

US 2019012876, incorporated herein by reference, provides projections, predictions, and recommendations for computing system.

US 2019332895, incorporated herein by reference, shows that the monitored states are to decide to change a trained ML model as currently used.

EP 4075348, incorporated herein by reference, describes control of machine learning model, which can be based on a federated learning method collectively performed by nodes of a decentralized distributed database.

US 2021019612, incorporated herein by reference, provides the self-healing system that can automatically provide a diagnostic, and it can also automatically provide an action if the performance of the model predictions has changed over time.

Followingly, in Release 18 the new work item of “Artificial Intelligence (AI)/Machine Learning (ML) for NG-RAN”, incorporated herein by reference, was initiated to specify data collection enhancements and signaling support within existing NG-RAN interfaces and architecture. For the above active standardization works, model identification to support RAN-based AI/ML model is considered very significant for both network and UE to meet any desired model operations (e.g., model training, inference, selection, switching, update, monitoring, etc.). Currently, there is no definition for signaling methods or gNB-UE behaviors about supporting AI/ML model switching operation with model ID. Especially when the applied use case is latency-sensitive, any performance degradation (e.g., model drift) with AI/ML model can cause critical problem due to drift. Model switching can also go through additional delay due to the related signaling and switching operation. As a result, procedure and signaling between gNB and UE need to be specified to support AI/ML model switching via model ID so as to minimize performance impact.

### SUMMARY OF THE INVENTION

Therefore this application gives a solution to that described problem.

The problem is solved by the embodiments described. A method of model switching signaling for radio access network by preparing a list of candidate AI/ML models in advance for model switching, where Model switching ID profile containing a list of candidate models is generated to indicate alternative model from the candidate model IDs that is then applied when model switching needs to be activated. Model switching ID profile is sent to UE when initial model for activation is determined based on a given specific use case or application to use AI/ML model operation. Alternative model(s) is selected based on the pre-configured mapping relationship information included in model switching ID profile for model switching.

UE can immediately perform model switching using model switching ID profile autonomously. UE reports the updated model ID to gNB (e.g., through L1/L2 signaling) after model switching is performed.

In some embodiments of the method according to the first aspect, the method is characterized by, that the model switching ID profile is sent to UE through RRC reconfiguration message.

In some embodiments of the method according to the first aspect, the method is characterized by, that the UE reports the updated model ID to gNB through L1/L2 signaling.

In some embodiments of the method according to the first aspect, the method is characterized by, that the model switching ID profile is based on mapping relationship between alternative candidate model IDs and the associated data values or index where

gNB provides a look-up table(s) indicating alternative model IDs for different associated values or index. UE specific signaling message via RRC and/or MAC CE and/or DCI are used for multiple look-up tables of indicating alternative candidate model IDs.

In some embodiments of the method according to the first aspect, the method is characterized by, that the one or multiple model switching ID profiles sent to UE in different use cases where the profile content can be pre-configured with a plurality of parameter sets related to model/device/environmental information.

In some embodiments of the method according to the first aspect, the method is characterized by, that the model switch is triggered based on the pre-configured criteria and UE executes model switching by replacing the current model with alternative model(s) from the model switching ID profile(s), UE can autonomously switch models without exchanging any signaling during model switching phase.

In some embodiments of the method according to the first aspect, the method is characterized by, that the gNB uses the repository information related to model switching ID updates so that candidate model list for model switching is acquired, wherein gNB obtains the UE ML capability information in advance before determining candidate model list for model switching.

In some embodiments of the method according to the first aspect, the method is characterized by, that the gNB alternatively decides model switching for UE after getting feedback from UE about model performance status and gNB sends the determined model information for model switching to UE so that UE can apply the indicated alternative model accordingly.

In some embodiments of the method according to the first aspect, the method is characterized by, that the mapping relationship IDs in model switching ID profile is based on the initial/current model ID and the associated parameter set ID information such as drift, dataset, etc. where Initial model ID, as an example, provides the limited range of alternative model IDs for model switching and drift ID indicates model drift type and/or pattern information for the categorized identification. Dataset ID contains statistical information such as degree of data distribution change for difference between current dataset and training dataset. Model switching ID profile can also contain the device-specific capability change IDs such as ML processing power, memory capacity level, and/or device battery power level, etc. to be associated with alternative model IDs. Model switching can be triggered from drift occurrence as well as device capability change then. Depending on model switching causes, different mapping relationship information for model switching ID profile can be generated with different parameter IDs. For each model switching ID profiles, a set of pre-defined configuration of settings and options can be contained (e.g., model-related, device vendor-related).

In some embodiments of the method according to the first aspect, the method is characterized by, that the multiple mapping profiles for model switching can be generated, depending on individual UE device, group of UEs with the same environmental conditions), UE vendor-specific group, etc. where Group-or cell-based indications about a list of candidate models for model switching can be performed (e.g., through system information or RRC signaling). For the candidate models to be alternative to the initial/current model, some of those models can be pre-loaded for execution in advance so that model switching can be quickly processed.

In some embodiments of the method according to the first aspect, the method is characterized by, that the model switching ID profile can be generated for multiple types such as network model switching ID profiles (NMSIP) and device model switching ID profiles (DMSIP) wherein NMSIP is generated by network side that can be shared with UE device side and DMSIP is generated by UE side that can be shared with network side. In generating a list of candidate models for any specific model switching, any additional updated version of candidate models through model switching ID repository can be included into model switching ID profile.

In some embodiments of the method according to the second aspect, the Apparatus preparing a list of candidate AI/ML models in advance for model switching, the apparatus comprising a wireless transceiver, a processor coupled with a memory in which computer program instructions are stored, said instructions being configured to implement steps according to a first aspect of the of the present disclosure.

According to a third aspect, the present disclosure relates to a user Equipment comprising an apparatus according to any one of the embodiments of the second aspect.

According to a fourth aspect, the present disclosure relates to a user base station comprising an apparatus according to any one of the embodiments of the second aspect.

According to a fifth aspect, the present disclosure relates to a wireless communication system, wherein the base station comprises a processor coupled with a memory in which computer program instructions are stored, said instructions being configured to implement the steps according to the first aspect.

wherein the user equipment (UE) comprises a processor coupled with a memory in which computer program instructions are stored, said instructions being configured to implement the steps according to the first aspect.

### BRIEF DESCRIPTION OF THE DRAWINGS

FIG. 1 is an exemplary diagram of autonomous model switching on UE side.

FIG. 2 is an exemplary table of model switching ID profile based on mapping relationship.

FIG. 3 is a flow chart of model switching profile procedure for gNB behavior.

FIG. 4 is a flow chart of model switching profile procedure for UE behavior.

FIG. 5 is a signaling flow of model switching by UE.

FIG. 6 is a signaling flow of model switching by gNB.

FIG. 7 is a block diagram of mapping of data IDs into model switching IDs.

FIG. 8 is a block diagram of model switching ID profile generation.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the fimctions/acts specified in the flowchart diagrams and/or block diagrams

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements

The description of elements in each figure may refer to elements of proceeding figures. Like numbers refer to like elements in all figures, including alternate embodiments of like elements.

The detailed description set forth below, with reference to the figures, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. For instance, although 3GPP terminology, from e.g., 5G NR, may be used in this disclosure to exemplify embodiments herein, this should not be seen as limiting the scope of the present disclosure.

The disclosure is related to wireless communication system, which may be for example a 5G NR wireless communication system. More specifically, it represents a RAN of the wireless communication system, which is used exchange data with UEs via radio signals. For example, the RAN may send data to the UEs (downlink, DL), for instance data received from a core network (CN). The RAN may also receive data from the UEs (uplink, UL), which data may be forwarded to the CN.

In the examples illustrated, the RAN comprises one base station, BS. Of course, the RAN may comprise more than one BS to increase the coverage of the wireless communication system. Each of these BSs may be referred to as NB, eNodeB (or eNB), gNodeB (or gNB, in the case of a 5G NR wireless communication system), an access point or the like, depending on the wireless communication standard(s) implemented.

The UEs are located in a coverage of the BS. The coverage of the BS corresponds for example to the area in which UEs can decode a PDCCH transmitted by the BS.

An example of a wireless device suitable for implementing any method, discussed in the present disclosure, performed at a UE corresponds to an apparatus that provides wireless connectivity with the RAN of the wireless communication system, and that can be used to exchange data with said RAN. Such a wireless device may be included in a UE. The UE may for instance be a cellular phone, a wireless modem, a wireless communication device, a handheld device, a laptop computer, or the like. The UE may also be an Internet of Things (IoT) equipment, like a wireless camera, a smart sensor, a smart meter, smart glasses, a vehicle (manned or unmanned), a global positioning system device, etc., or any other equipment that may run applications that need to exchange data with remote recipients, via the wireless device.

The wireless device comprises one or more processors and one or more memories. The one or more processors may include for instance a central processing unit (CPU), a digital signal processor (DSP), a field-programmable gate array (FPGA), an application specific integrated circuit (ASIC), etc. The one or more memories may include any type of computer readable volatile and non-volatile memories (magnetic hard disk, solid-state disk, optical disk, electronic memory, etc.). The one or more memories may store a computer program product, in the form of a set of program-code instructions to be executed by the one or more processors to implement all or part of the steps of a method for exchanging data, performed at a UE's side, according to any one of the embodiments disclosed herein.

The wireless device can comprise also a main radio, MR, unit. The MR unit corresponds to a main wireless communication unit of the wireless device, used for exchanging data with BSs of the RAN using radio signals. The MR unit may implement one or more wireless communication protocols, and may for instance be a 3G, 4G, 5G, NR, WiFi, WiMax, etc. transceiver or the like. In preferred embodiments, the MR unit corresponds to a 5G NR wireless communication unit.

The following explanation will provide the detailed description of the mechanism about pre-configuring and signaling the specific information about mapping relationship information using association between models and other index values. AI/ML based techniques are currently applied to many different applications and 3GPP also started to work on its technical investigation to apply to multiple use cases based on the observed potential gains. AI/ML lifecycle can be split into several stages such as data collection/pre-processing, model training, model testing/validation, model deployment/update, model monitoring etc., where each stage is equally important to achieve target performance with any specific model(s). In applying AI/ML model for any use case or application, one of the challenging issues is to manage the lifecycle of AI/ML model. It is mainly because the data/model drift occurs during model deployment/inference and it results in performance degradation of AI/ML model.

Fundamentally, the dataset statistical changes occur after model is deployed and model inference capability is also impacted with unseen data as input. In a similar aspect, the statistical property of dataset and the relationship between input and output for the trained model can be changed with drift occurrence. In this context, model switching/selection is one of key issues for model performance maintenance as model performance such as inferencing and/or training is dependent on different model execution environment with varying configuration parameters. To handle this issue, collaboration between UE and gNB is highly important to track model performance and re-configure model corresponding to different environments. AI/ML model needs model monitoring after deployment because model performance cannot be maintained continuously due to drift and update feedback is then provided to re-train/update the model or select alternative model.

When AI/ML model enabled wireless communication network is deployed, it is then important to consider how to handle AI/ML model in activation with re-configuration for wireless devices under operations such as model training, inference, updating, etc. When AI/ML model enabled wireless communication network is deployed, it is then important to consider how to handle AI/ML model in activation with re-configuration for wireless devices under operations such as model training, inference, updating, etc. For example, AI/ML based beam management is being considered in 3GPP for evaluation and AI/ML based beam management would fail if model performance is degraded because model provides inaccurate channel quality measurement (e.g., drift occurrence).

Therefore, a new mechanism about gNB-UE behaviors and procedures is needed to avoid any performance impact on model switching operation when using a finite set of specific AI/ML model IDs. Based on a given specific use case or application to use AI/ML model operation, the model functionality and the associated model identification are configured on network side. A list of candidate AI/ML models is prepared for model switching in advance and sent to UE (e.g., through RRC reconfiguration message) when initial model for activation is determined. Model switching ID profile containing those candidate models is generated to indicate alternative model from the candidate model IDs that is then applied when model switching needs to be activated.

For model switching, alternative model is selected based on the pre-configured mapping relationship information. For example, mapping relationship between drift identification index and alternative model IDs (e.g., related to changes of dataset characteristics and current model performance). During model monitoring phase, UE can immediately perform model switching using model switching ID profile autonomously. After model switching, UE reports the updated model ID to gNB (e.g., through L1/L2 signaling).

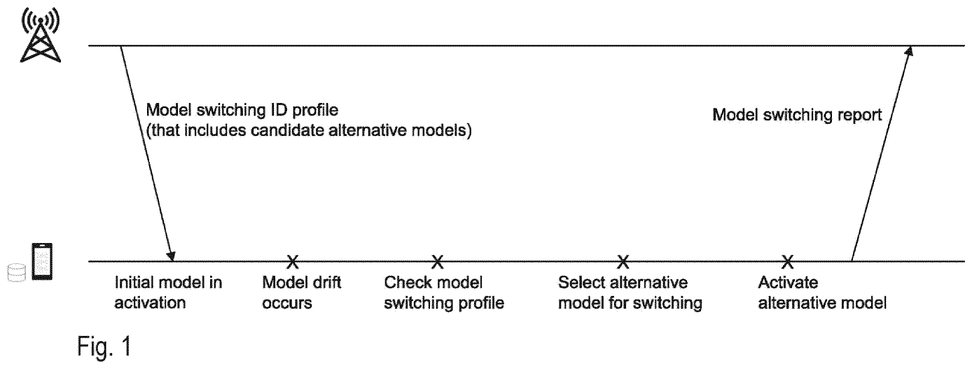

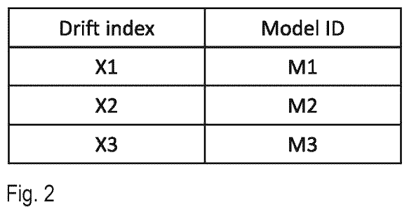

FIG. 1 shows an exemplary diagram of autonomous model switching on UE side and when the initial or current model has drift or performance degradation, UE can execute model switching autonomously based on model switching profile. In this example, on UE side the initial model is activated and gNB sends model switching ID profile that includes alternative candidate models. UE detects drift occurrence and alternative model for switching is selected from the given model switching profile. After activation of the selected alternative model, UE reports this update to gNB. FIG. 2 shows an exemplary table of model switching ID profile based on mapping relationship and gNB provides mapping between drift value index and model ID through UE specific signaling message (e.g., RRC, MAC CE, or DCI). UE checks current drift value with the table provided by gNB and selects model ID accordingly. For example, gNB provides a look-up table indicating alternative model IDs for different associated drift value index. Based on this exemplary table, if UE determines drift value as index for X2 then UE selects model ID for M2.

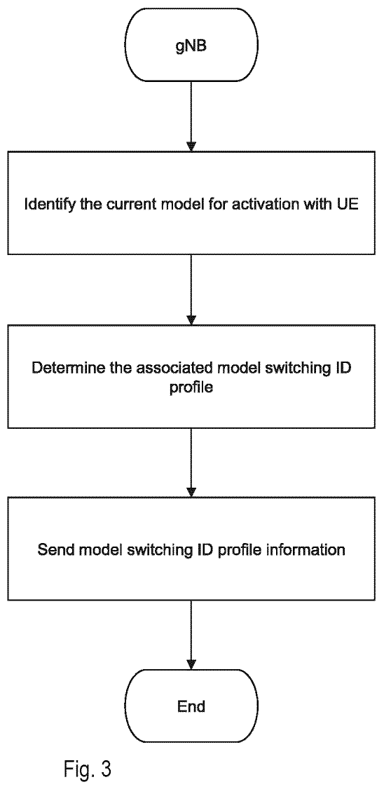

FIG. 3 shows a flow chart of model switching profile procedure for gNB behavior and the initial or current model for activation for UE is firstly identified. Based on this, the associated model switching ID profile is determined wherein the profile content can be pre-configured with a plurality of parameter sets related to model/device/environmental informations. gNB then sends the selected model switching ID profile and multiple profiles can be also sent to UE in different use cases.

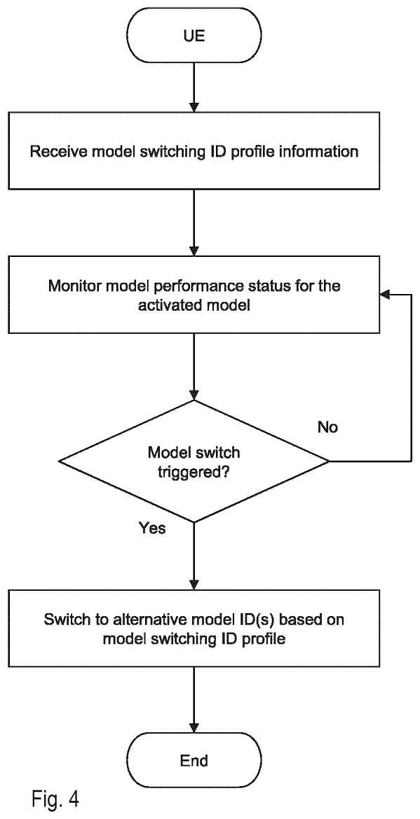

FIG. 4 shows a flow chart of model switching profile procedure for UE behavior and model monitoring is in operation during model inference phase so as to detect model performance degradation with drift occurrence as an example. If model switch is triggered based on the pre-configured criteria, UE executes model switching by replacing the current model with alternative model(s) from the model switching ID profile(s). In this example, UE can autonomously switch models without exchanging any signaling during model switching phase.

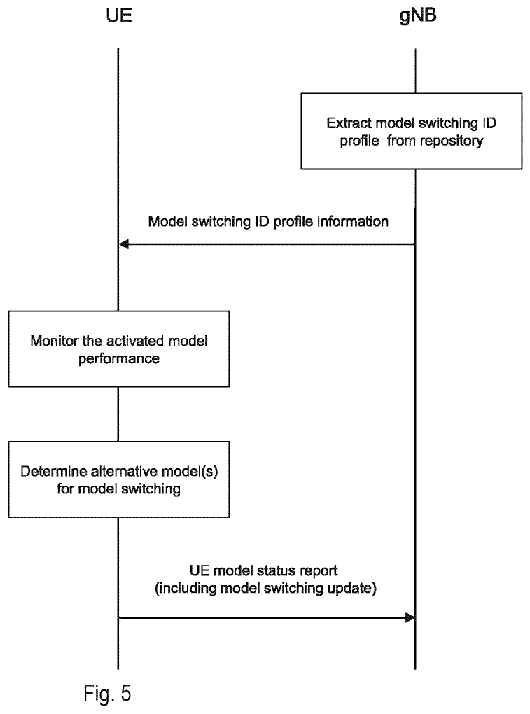

FIG. 5 shows a signaling flow of model switching by UE and gNB uses the repository information related to model switching ID updates wherein candidate model list for model switching can be acquired. gNB also might need to obtain the UE ML capability information in advance before determining candidate model list for model switching.

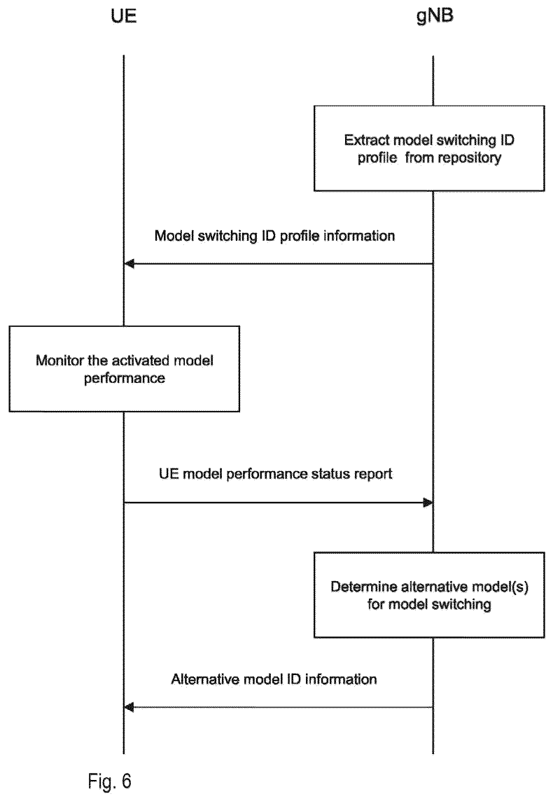

FIG. 6 shows a signaling flow of model switching by gNB and this example shows that gNB decides model switching for UE after getting feedback from UE about model performance status. In this case, gNB sends the determined model information for model switching to UE so that UE can apply the indicated alternative model accordingly.

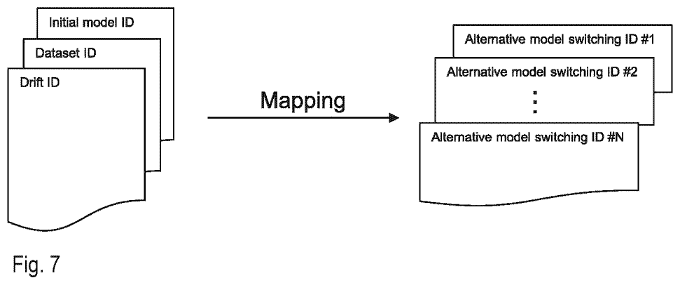

FIG. 7 shows a block diagram of mapping of data IDs into model switching IDs and mapping relationship IDs in model switching ID profile is based on the initial/current model ID and the associated parameter set ID information such as drift, dataset, etc. In this example, initial model ID provides the limited range of alternative model IDs for model switching and drift ID indicates model drift type and/or pattern information for the categorized identification. And dataset ID contains statistical information such as degree of data distribution change for difference between current dataset and training dataset. On the other hand, model switching ID profile can also contain the device-specific capability change IDs such as ML processing power, memory capacity level, and/or device battery power level, etc. to be associated with alternative model IDs. Model switching can be triggered from drift occurrence as well as device capability change then. Depending on model switching causes, different mapping relationship information for model switching ID profile can be generated with different parameter IDs. For each model switching ID profiles, a set of pre-defined configuration of settings and options can be contained (e.g., model-related, device vendor-related). Multiple mapping profiles for model switching can be generated, depending on individual UE device, group of UEs (e.g., with the same environmental conditions), UE vendor-specific group, etc.

UE vendor-specific mapping for model switching ID profile is also available and this information is sent through UE vendor-specific groupcast and any additional updates about this mapping information can be sent through UE dedicated signaling if necessary.

Group- or cell-based indications about a list of candidate models for model switching can be performed (e.g., through system information or RRC signaling). For example, there are a group of UEs that are co-located each other and similar drift is observed with the correlated environmental conditions. gNB provides location-based and/or beam-specific mapping relationship information between model IDs and drift index for this UE group.

For the candidate models to be alternative to the initial/current model, some of those models can be pre-loaded for execution in advance so that model switching can be quickly processed.

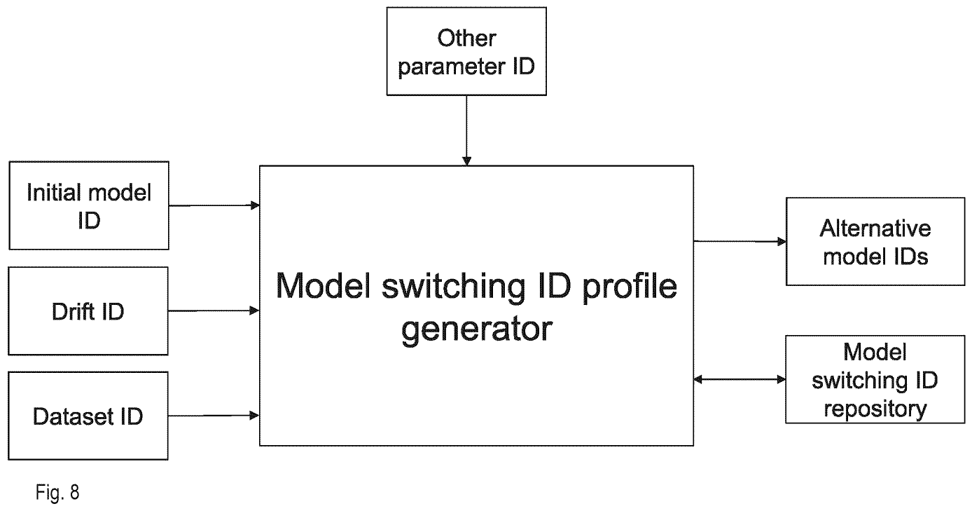

FIG. 8 shows a block diagram of model switching ID profile generation and model switching ID profile can be generated for multiple types such as network model switching ID profiles (NMSIP) and device model switching ID profiles (DMSIP) wherein NMSIP is generated by network side that can be shared with UE device side and DMSIP is generated by UE side that can be shared with network side. In generating a list of candidate models for any specific model switching, any additional updated version of candidate models through model switching ID repository is considered to be included into model switching ID profile. In this example, a few identification parameter values are considered such as initial model ID, drift ID and dataset ID to generate alternative candidate models for model switching. However, other parameter values can be also considered in the form of IDs such as device ML capability status update, model operation environmental information.

The proposed method of model switching has benefits for model performance enhancement. When model drift is detected through model monitoring, the immediate model switching can be executed using model switching profile information and this would reduce latency from the performance gap impact due to drift occurrence. As alternative model IDs are prepared in advance through model switching profile, signaling exchange can be reduced as UE can execute model switching locally without depending on network side after obtaining model switching profile information.

1. A method of model switching signaling for radio access network by preparing a list of candidate AI/ML models in advance for model switching, where
a Model switching ID profile containing a list of candidate models is generated to indicate alternative model from the candidate model IDs that is then applied when model switching needs to be activated;
a Model switching ID profile is sent to a User Equipment (UE) when initial model for activation is determined based on a given specific use case or application to use AI/ML model operation;
an Alternative model(s) is selected based on the pre-configured mapping relationship information included in model switching ID profile for model switching;
the UE can immediately perform model switching using model switching ID profile autonomously;
the UE reports the updated model ID to gNB (e.g., through L1/L2 signaling) after model switching is performed.

2. The method according to claim 1, wherein the model switching ID profile is sent to UE through RRC reconfiguration message.

3. The method according to claim 1, wherein the UE reports the updated model ID to gNB through L1/L2 signaling.

4. The method according to claim 1, wherein the model switching ID profile is based on mapping relationship between alternative candidate model IDs and the associated data values or index where
the gNB provides a look-up table(s) indicating alternative model IDs for different associated values or index;
the UE specific signaling message via RRC and/or MAC CE and/or DCI are used for multiple look-up tables of indicating alternative candidate model IDs.

5. The method according to claim 1, wherein one or multiple model switching ID profiles sent to the UE in different use cases where the profile content can be pre-configured with a plurality of parameter sets related to model/device/environmental information.

6. The method according to claim 1, wherein the model switch is triggered based on the pre-configured criteria and the UE executes the model switching by replacing the current model with alternative model(s) from the model switching ID profile(s), the UE can autonomously switch models without exchanging any signaling during model switching phase.

7. The method according to claim 1, wherein the gNB uses the repository information related to model switching ID updates so that candidate model list for model switching is acquired, wherein the gNB obtains the UE ML capability information in advance before determining candidate model list for model switching.

8. The method according to claim 1, wherein the gNB alternatively decides model switching for the UE after getting feedback from the UE about model performance status and the gNB sends the determined model information for model switching to the UE so that the UE can apply the indicated alternative model accordingly.

9. The method according to claim 1, wherein mapping relationship IDs in the model switching ID profile is based on the initial/current model ID and the associated parameter set ID information such as drift, dataset, etc. where
an Initial model ID, as an example, provides the limited range of alternative model IDs for model switching and drift ID indicates model drift type and/or pattern information for the categorized identification, the Dataset ID contains statistical information such as degree of data distribution change for difference between current dataset and training dataset;
the Model switching ID profile can also contain the device-specific capability change IDs such as ML processing power, memory capacity level, and/or device battery power level, to be associated with alternative model IDs; the Model switching can be triggered from drift occurrence as well as device capability change then;
Depending on model switching causes, different mapping relationship information for the model switching ID profile can be generated with different parameter IDs, for each model switching ID profiles, a set of pre-defined configuration of settings and options can be contained.

10. The method according to claim 1, wherein multiple mapping profiles for model switching can be generated, depending on individual the UE device, group of UEs, UE vendor-specific group, where
Group- or cell-based indications about a list of candidate models for model switching can be performed;
For the candidate models to be alternative to the initial/current model, some of those models can be pre-loaded for execution in advance so that model switching can be quickly processed.

11. The method according to claim 1, wherein the model switching ID profile can be generated for multiple types such as network model switching ID profiles (NMSIP) and device model switching ID profiles (DMSIP) wherein the NMSIP is generated by network side that can be shared with the UE device side and the DMSIP is generated by the UE side that can be shared with the network side, in generating a list of candidate models for any specific model switching, any additional updated version of candidate models through model switching ID repository can be included into the model switching ID profile.

12. An apparatus preparing a list of candidate AI/ML models in advance for model switching, the apparatus comprising a wireless transceiver, a processor coupled with a memory in which computer program instructions are stored, said instructions being configured to implement the method of claim 1.

13. User Equipment comprising an apparatus according to claim 12.

14. A base station comprising an apparatus according to claim 12.

15. A wireless communication system, comprising a base station and user equipment (UE), wherein the base station comprises a processor coupled with a memory in which computer program instructions are stored, and wherein the UE comprises a processor coupled with a memory in which computer program instructions are stored, said computer program instructions in each of the base station and the user equipment being configured to implement the method of claim 1.
